(19) United States
(12) Patent Application Publication
(10) Pub. No.: US 2004/0091070 A1
(43) Pub. Date: May 13, 2004

(54) Equalizer for a single-carrier receiver and equalization method therefor

(75) Inventors: Jae-Hyon Kim, Gyunggi-do (KR); Hae-Sock Oh, Daegu-City (KR); Dong-Seog Han, Daegu-city (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd.

(21) Appl. No.: 10/645,482

(22) Filed: Aug. 22, 2003

(30) Foreign Application Priority Data
Nov. 8, 2002 (KR) 2002-69008

(51) Int. Cl. H04B 1/10

(52) U.S. Cl. 375/350

(57) ABSTRACT

An equalizer for a single-carrier receiver having an enhanced convergence speed and a steady equalization performance. A filter unit filters received multi-path signals. A field synch extractor extracts a field synch signal having two signals of different levels from the received signals and a field synch storage unit stores a kth field synch signal of the extracted field synch signal. An error calculator N times repeatedly uses the kth field synch signal and calculates equalization error values, wherein the filter unit uses the equalization error values to update coefficients of the filters. Accordingly, the equalizer N times repeats the kth field synch signal to be compared to a reference signal generated from the field synch generator, so as to be operated in a training mode, to thereby enhance the convergence speed of the equalizer.

### CROSS REFERENCE TO RELATED APPLICATIONS

This application claims the benefit of Korean Application No. 2002-69008, filed Nov. 8, 2002, in the Korean Intellectual Property Office, the disclosure of which is incorporated herein by reference.

### BACKGROUND OF THE INVENTION

1. Field of the Invention

The present invention relates to an equalizer for a single-carrier receiver and a method of equalizing a signal in a single carrier receiver, and more particularly, to an equalizer having an enhanced convergence speed and a steady equalization performance and a method of equalizing a signal with enhanced convergence speed and steady equalization performance.

2. Description of the Related Art

Many countries are digitalizing existing analog broadcasts with communications, computers, and broadcasts fused together in multimedia. In particular, digital broadcasts are partially performed through satellites already in the advanced countries, including the United States of America (USA), European countries and Japan. Further, a standard code for the digital broadcasts has been prepared but may be configured a bit different country by country.

The Federal Communications Commission (FCC) of the USA approved the digital television standard of the Advanced Television Systems Committee (ATSC) as a next generation TV broadcast standard on Dec. 24, 1996. With the approval, the ATSC standards for video and audio compressions, packet data transfer structures, and modulation and transfer systems must be observed by ground wave broadcasters. However, the standards for video formats have not been particularly regulated in order to be voluntarily decided by related industry sectors.

The ATSC standards have chosen MPEG-2 video (ISO/IECIS13818) standard format as a video compression format, wherein the MPEG stands for Moving Picture Experts Group, which has been worldwide chosen as the standard for all the digital broadcasts. For the audio compression formats, the digital audio compression AC-3 standard format proposed by Dolby Corporation has been chosen. The format is being used even in the European format like the video compression format. The 8-VSB format has been chosen for the modulation and transfer format, wherein the VSB stands for Vestigial Sideband. The VSB format, which has been proposed for digital TV broadcasts, uses the 6 MHz bandwidth, enables a data transfer rate of 19.39 Mbps, and has a simple structure with high bandwidth efficiency. Further, the VSB format has been designed to minimize interference with the existing National Television Standards Committee (NTSC) broadcast channels, and the VSB format uses a pilot signal, a segment synch signal and a field synch signal, to steadily operate even in states where a great amount of noise is involved.

The ATSC digital TV standard uses the single-carrier VSB format, transfers high-quality video, audio, and auxiliary data with a 6 MHz bandwidth, and supports two broadcast modes, that is, the real-time ground wave broadcast mode and the high-speed data rate cable broadcast mode. A significant feature is that this format uses the 8-VSB modulation format in order to enable the digital signal modulation, transforming the existing analog VSB format.

FIG. 1 is a block diagram for schematically showing a single-carrier receiver to which such a VSB modulation format is applied. The receiver has an RF unit 10, an analog-to-digital converter 20, a synchronizer 30, an equalizer 40, a decoder 50, and a field synch signal generator 60.

The RF unit 10 selects a received broadcast signal from an antenna 11 and converts the broadcast signal of the selected bandwidth into a baseband signal. The ADC unit 20 digital-samples the received broadcast signal of analog format and converts the received broadcast signal into a digital format. The synchronizer 30 compensates for frequency, phase, and timing offsets with respect to the input broadcast signal. The equalizer 40 compensates for channel distortions occurring on a transmission channel with respect to the offset-compensated broadcast signal. The decoder 50 decodes the data of the broadcast signal equalized in the equalizer 40.

FIG. 2 is a view for showing an ATSC frame structure. As shown in FIG. 2, an ATSC field consists of 313 consecutive segments, and the ATSC field synchronization fieldsynch consists of one segment. The ATSC frame structure consists of two ATSC fields.

FIG. 3 is a view for showing a field synch signal. The field synch signal consists of a segment synch signal having 4 symbols, a pseudo-noise sequence (hereinafter, referred to as PN sequence) having 511 symbols, three PN sequences having 63 symbols, a transfer mode (VSB mode) having 24 symbols, 92 reserved symbols, and 12 precode symbols. In the field sync signal, only the 12 precode symbols have 8 levels, and the remaining symbols have 2 levels.

In a general ATSC frame structure as shown in FIGS. 2 and 3, the conventional equalizer uses 700 symbols with respect to the PN sequence of the field synch signal (fieldsync) which is periodically input, and operates in a training mode. Further, the equalizer operates in a blind mode with respect to data other than the fieldsynch data.

FIG. 4 is a block diagram for showing the equalizer 40 of FIG. 1 in detail, the equalization operations of which are described with a decision feedback equalization, for example.

The equalizer 40 comprises a feed-forward (FF) part 41 having filters of an FIR configuration which remove a pre-ghost received prior to a main ghost, which is the strongest signal of input signals, a feedback (FB) part 42 having filters of an IIR configuration which removes the post-ghost received after the main ghost, a field synch extractor 45 which extracts a field synch signal of the input signals, a channel estimator 45 which uses the extracted field synch signal to initialize respective filter tap coefficients of the FF part 41 and the FB part 42 and predicts a channel status, and a switching unit 49 which selectively switches equalization error values err_blind and err_train calculated in correspondence to the blind mode and the training mode, respectively, which are the operation modes of the equalizer and inputs the equalization error values err_blind and err_train to the FF part 41 and the FB part 42.

That is, the FF part 41 and the FB part 42 update the respective filter tap coefficients in correspondence to the input equalization error values err_blind and err_train and filter the input multi-path signals.

The equalizer 40 further comprises a first adder 43, a second adder 48, a third adder 46 and a decision unit 47. Where the operation mode of the equalizer 40 is the training mode, the switching unit 49 switches the equalization error values err_train corresponding to the training mode. The field synch extractor 45 extracts a field synch signal of the signals input to the equalizer 40. The third adder 46 adds the extracted field synch signal and the reference signal generated from the field synch generator 60 and outputs the equalization error values err_train. At this time, based on the equalization error values err_train selected by the switching unit 49, the FF part 41 and the FB part 42 update the respective filter tap coefficients so that the equalizer converges.

Where the operation mode of the equalizer 40 is the blind mode, the switching unit 49 switches the equalization error values err_blind corresponding to the blind mode. The respective output signals of the FF part 41 and the FB part 42 are added by the first adder 43 to be set to an arbitrary level in the decision unit 47. The second adder 48 adds an output signal of the first adder 43 and an output signal of the decision unit 47 and outputs the equalization error values err_blind. At this time, based on the equalization error values err_blind selected by the switching unit 49, the FF part 41 and the FB part 42 update the respective filter tap coefficients based on the equalization error values err_blind so that the equalizer converges.

Accordingly, where the equalizer 40 operates in the training mode and performs equalizations based on the reference signal generated in the field synch generator 60, the convergence speed of the equalizer becomes high. However, the general equalizer of the related art operates, with respect to the entire ATSC frame structure, for a relatively short period of time in the training mode compared to a period of time during which the blind mode operates, causing a problem in that the equalizer takes a longer convergence time for a safe convergence.

### SUMMARY OF THE INVENTION

In order to solve the above and/or other problems, it is an aspect of the present invention to provide an equalizer for a single-carrier receiver and a method of equalization which enable the equalizer to enhance an equalization convergence speed as well as have a steady equalization performance.

Additional aspects and advantages of the invention will be set forth in part in the description which follows and, in part, will be obvious from the description, or may be learned by practice of the invention.

In order to achieve the above and/or other aspects of the invention, an equalizer for a single-carrier receiver according to the present invention comprises a filter unit having filters which filters received multi-path signals; a field synch extractor which extracts a field synch signal having two signals of different levels from the received signals; a field synch storage unit which stores a kth field synch signal (k is a natural number) of the extracted field synch signal; and an error calculator which N times repeatedly uses the kth field synch signal and calculates equalization error values, wherein the filter unit uses the equalization error values to update coefficients of the filters.

The error calculator comprises a first recycle mode which M times repeatedly uses the kth field synch signal to calculate the equalization error values (M is a natural number, satisfying M<N), and the first recycle mode calculates the equalization error values in training and blind modes with respect to one of the two signals of the kth field synch signal. Further, the error calculator has a second recycle mode which (N−M) times repeatedly uses the kth field synch signal to calculate the equalization error values, and the second recycle mode calculates the equalization error values in the training and blind modes with respect to one of the two signals except for a part including pre-ghost and post-ghost of the other of the two signals. Further, the equalization error values become ‘0’ with respect to the one of the two. The one of the two signals is a two-level signal, and the other of the two signals is an eight-level signal.

The error calculator comprises, in the training mode, a field synch generator which generates a reference signal; and an adder which adds the kth field synch signal and the reference signal to calculate the equalization error values, and the error calculator includes, in the blind mode, a decision unit which outputs the input kth field synch signal as a predetermined level; and another adder which adds the kth field synch signal input to the decision unit and the output signal of the predetermined level to calculate the equalization error values.

Further, a method of equalizing a single-carrier receiver according to the present invention comprises filtering received multi-path signals; extracting a field synch signal having two signals of different levels from the received signals; storing a kth field synch signal (k is a natural number) of the extracted field synch signal; calculating the equalization error values by N times repeatedly using the kth field synch signal to calculate the equalization error values; and updating coefficients of filters which filter the received multi-path signals; and filtering the multi-path signals through the coefficients-updated filters.

The calculating of the equalization error values further comprises a first recycle mode which M times repeatedly uses the kth field synch signal to calculate the equalization error values (M is a natural number, satisfying M<N), and the first recycle mode calculates the equalization error values in training and blind modes with respect to one of the two signals.

The calculating of the equalization error values further comprises a second recycle mode which (N−M) times repeatedly uses the kth field synch signal to calculate the equalization error values, and the second recycle mode calculates the equalization error values in the training and blind modes with respect to one of the two signals except for a part including pre-ghost and post-ghost of the other of the two signals. Further, The equalization error values may become ‘0’ with respect to the one of the two signals. In the calculating of the equalization error values, the one of the two signals is a two-level signal, and the other is a eight-level signal.

The present invention stores a kth field synch signal, N times repeats the stored kth field synch signal to be compared with a reference signal generated from the field synch generator, and operates the equalizer in the training mode, to thereby enhance the convergence speed of the equalizer.

### BRIEF DESCRIPTION OF THE DRAWINGS

The above and/or other aspects, advantages and features of the present invention will become more readily appreciated from the following description of the preferred embodiments taken in conjunction with the accompanying drawings of which:

FIG. 1 is a block diagram of a conventional single-carrier receiver;

FIG. 2 is a view illustrating a structure of an ATSC frame;

FIG. 3 is a view illustrating a structure of a field synch signal of the ATSC frame structure;

FIG. 4 is a detailed block diagram of the equalizer of FIG. 1;

FIG. 5 is a detailed block diagram illustrating an equalizer 400 according to the present invention;

FIG. 6 is a flowchart illustrating an equalization method of the equalizer of FIG. 5;

FIG. 7 is a view illustrating an equalization operation of a kth field synch signal in a first recycle mode;

FIG. 8A is a view illustrating a filer tap coefficient after the first recycle mode;

FIG. 8B is a view illustrating the filer tap coefficient where the adaptive threshold value algorithm is applied with respect to FIG. 8A;

FIG. 9 is a view illustrating the equalization process of the kth field synch signal in a second recycle mode; and

FIG. 10 is a view illustrating an equalization process of a (k+1)th field synch signal.

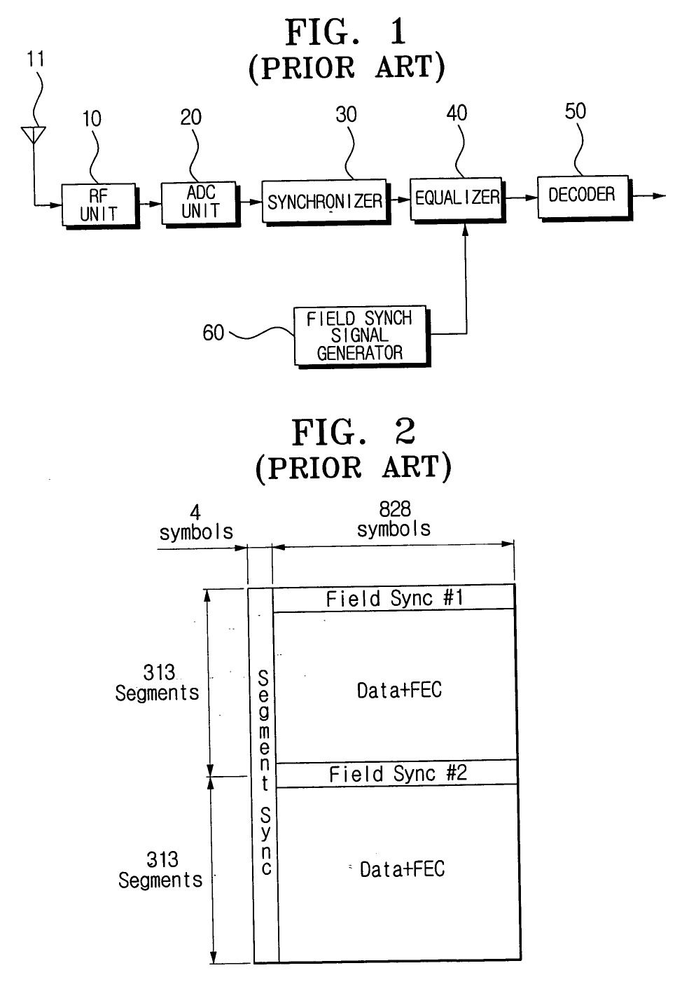

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

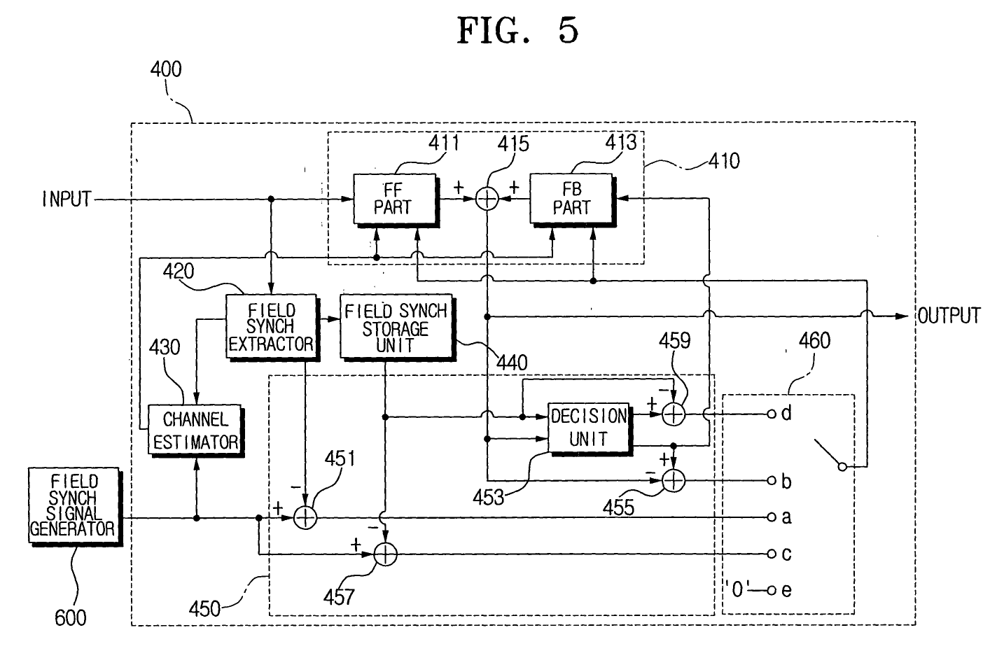

FIG. 5 is a block diagram for illustrating an equalizer according to an embodiment of the present invention.

An equalizer 400 comprises a filter unit 410 which filters received multi-path signals, a field synch extractor 420 which extracts a field synch signal from the received signals, a channel estimator 430 which predicts channel states of the received signals by using the extracted field synch signal, a field synch storage unit 440 which stores the extracted field synch signal, an error calculator 450 which calculates a plurality of equalization error values corresponding to a training mode and a blind mode respectively, and a switching unit 460 which selectively switches and provides one of the plurality of calculated equalization error values to the filter unit 410.

The filter unit 410 further comprises filters of a finite impulse response (FIR) filter configuration, having a feed forward (FF) part 411 having the finite impulse response (FIR) filter configuration, and which filter pre-ghost signals earlier received with respect to a main ghost of the received multi-path signals; a feedback (FB) part 413 having an infinite impulse response (FIR) filter configuration, and which filters post-ghost signals later received with respect to the main ghost; and a first adder 415 which adds a signal output from the FF part 411 and a signal output from the FB part 413, and to generate an output signal of the equalizer 400.

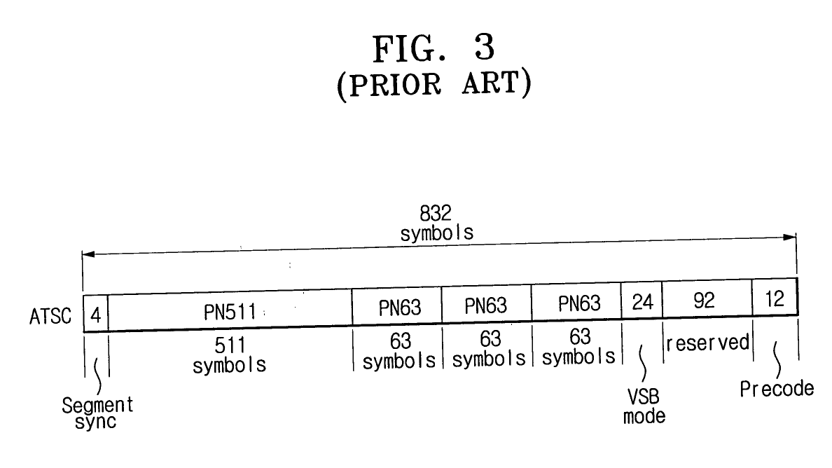

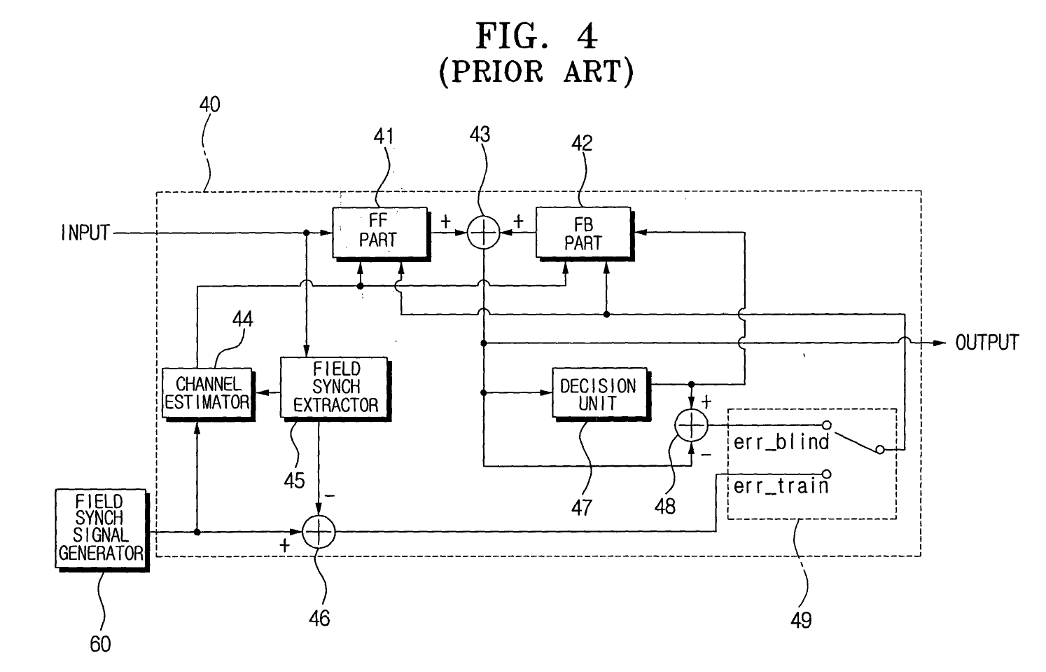

The field synch extractor 420 extracts and outputs a field synch signal of the received signals input to the equalizer 400. As shown in FIG. 3, the field synch extractor 420 extracts a field synch signal consisting of a segment synch signal having four symbols, four PN sequences having 700 symbols (511+3*63), transfer mode information having 24 symbols, reserved information having 92 symbols, and a precode having 12 symbols.

Referring again to FIG. 5, the channel estimator 430 predicts a channel status, using the field synch signal extracted by the field synch extractor 420 and a reference signal generated in a field synch generator 600. The channel estimator 430 initializes the FIR and IIR filter tap coefficients of the FF part 411 and the FB part 413, based on the predicted channel status.

The field synch storage unit 440 stores the field synch signal extracted by the field synch extractor 420. Using the stored field synch signal, the error calculator 450 operates in first and second recycle modes which are describe below, and calculates equalization error values c, d, and e.

The error calculator 450 calculates equalization error values a, b, c, and d corresponding to operation modes of the equalizer 400. Where the equalizer 400 operates in the training mode, a second adder 451 adds the reference signal generated by the field synch generator 600 and the field synch signal extracted from the field synch extractor 420 to calculate the equalization error value a, whereas, where the equalizer 400 operates in the blind mode, a third adder 455 adds signals input to and output from a decision unit 453 to calculate the equalization error value b. Calculations of the error values c and d are further explained below.

The switching unit 460 selectively provides the equalization error values a, b, c and d calculated based on the operation modes of the equalizer 400 and an error value e, determined as explained below, to the filter unit 410. The FF part 411 and FB part 413 of the filter unit 410 update respective tap coefficients corresponding to the switched equalization error values a, b, c, d, and e so that the equalizer 400 converges.

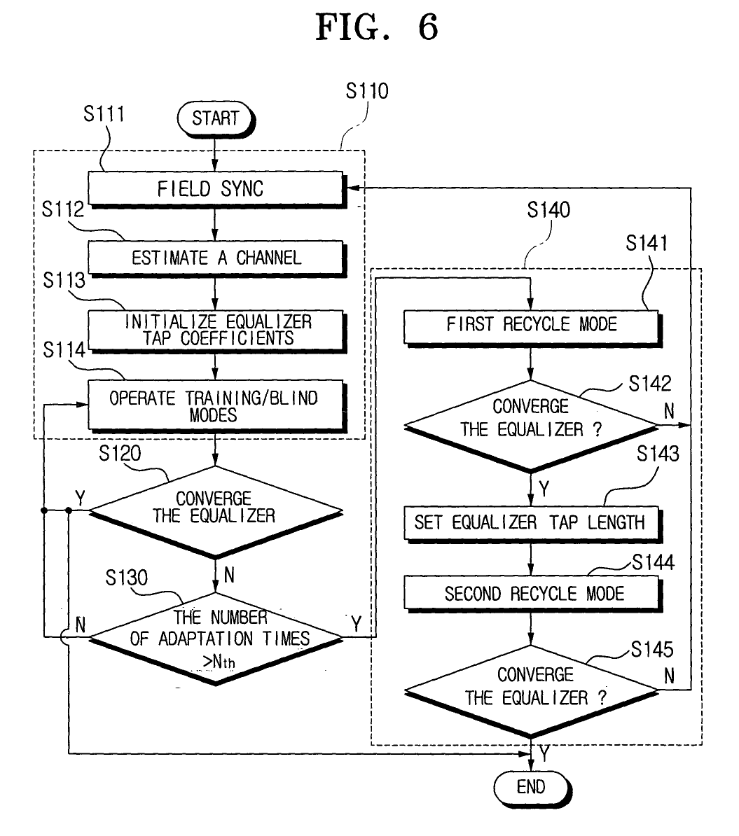

Hereinafter, a method of operation for the equalizer 400 according to the present invention is described in detail with reference to FIGS. 6-9.

FIG. 6 is a flow chart for showing a method of equalizing according to the present invention through a first equalization process S110 and a second equalization process S140 by the equalizer 400

First, the first equalization process S110 is the same as an equalization process of a general equalizer. That is, if the equalizer 400 receives a signal, the field synch extractor 420 extracts a field synch signal from the received signal (S111). The channel estimator 430 predicts a channel status of the currently received signal, using the PN sequences having 700 symbols (511+3*63), as shown in FIG. 3 (S112).

The FF part 411 and FB part 413 initialize the tap coefficients of the respective FIR filter and IIR filter based on the predicted channel status (S113). From the initialized filter tap coefficients of the FF part 411 and FB part 413, the FF part 411 and FB part 413 alternately perform equalization on the received signal in the training and blind modes so that the equalizer 400 converges (S114).

That is, the parts 411 and 413 operate in the training mode with respect to a two-level signal of the field synch signal to calculate the synchronization error value a, and operate in the blind mode with respect to precode and data signals of an eight-level signal to calculate the synchronization error value b. At this time, the switching unit 460 selectively switches the synchronization error values a and b corresponding to the respective operation modes to provide the switched synchronization error values a and b to the FF part 411 and the FB part 413. Accordingly, the FF part 411 and the FB part 413 update the filter tap coefficients thereof corresponding to the synchronization error values a and b so that the equalizer 400 converges.

As described above, if the first synchronization process S110 is completed, it is determined whether the equalizer 400 converges (S120). The determination of whether the equalizer 400 converges is performed by comparing the synchronization error values of the equalizer 400 after the first synchronization process S110 is completed to the predetermined synchronization error values which are used as standards for the determination of convergence. The equalization operations are completed when the equalizer 400 converges as a result of the decision.

In the meantime, where a determination is made that the equalizer 400 does not converge and a number of equalization adaptation times is less than a number of threshold adaptation times Nth (S130), the equalization operation of an operation S114 of the first equalization process S110 continues. In the first equalization process S110, the unit applied to the equalization is each of 313 segment units having one field of the ATSC frame shown in FIG. 2. Accordingly, if the number of equalization adaptation times is 3, it is indicated that three segments are equalized.

If the equalizer 400 does not converge within the number of threshold adaptation times Nth, the equalizer 400 is converted to perform a second equalization process S140.

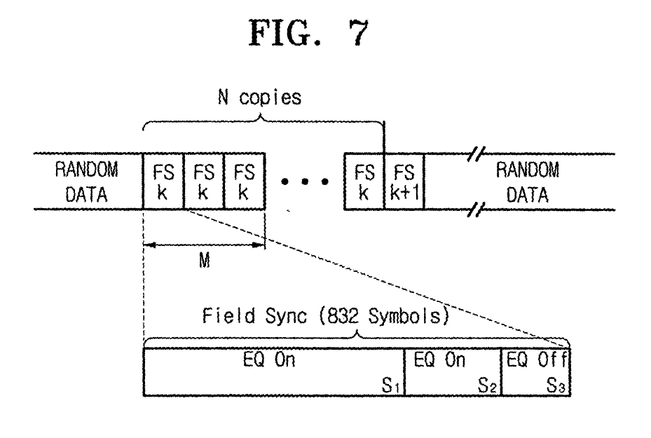

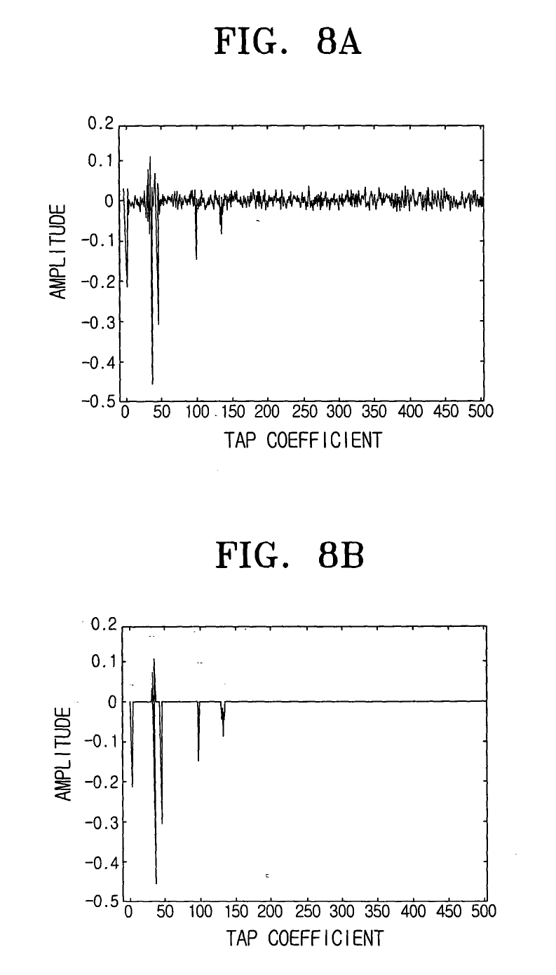

FIG. 7 and FIG. 8 are conceptual views for explaining the second equalization process S140, which are referred to for the explanation on the second equalization process S140 operating in the first and second recycle modes by using a field synch signal FS stored in the field synch storage unit 440.

The second equalization process S140 stores a kth (k is a natural number) field synch signal FS, which is input to the equalizer 400, to the field synch storage unit 440. The second equalization process S140 N times repeatedly compares the stored kth field synch signal FS to a reference signal generated from the field synch generator 600 (N is a natural number), calculates the equalization error values c, d, and e, and updates the filter tap coefficients of the FF part 411 and the FB part 413, so that the equalizer 400 converges.

First, the equalizer 400 uses the kth field synch signal FS and operates in the first recycle mode (S141). The equalizer 400 in the first recycle mode M times repeats the field synch signal FS (M<N, M is a natural number) and calculates the equalization error values c, d and e. The equalizer 400 uses the field synch signal FS (shown in FIG. 3) having a segment synch signal, PN sequences, transfer mode information, reserved information, and a precode and calculates the equalization error values c, d, and e.

Based on the first recycle mode, the field synch signal FS shown in FIG. 3 is divided into sections S₁, S₂ and S₃, as shown in FIG. 7, in order for equalization to be performed thereto. The section FS1 is one in which the two-level segment synch signal, PN sequences, and transfer mode information are carried, the section S₂ is one in which the two-level reserved information is carried, and the section S₃ is one in which the eight-level precode signal is carried.

That is, the training mode operates during the section S₁ where the segment synch signal, PN sequences, and transfer mode information are carried in order for a fourth adder 457 to calculate the equalization error value c, and the blind mode operates during the section S₂ where the reserved information is carried in order for a fifth adder 459 to calculate the equalization error value d. The FF part 411 and the FB part 413 update the respective filter tap coefficients based on the calculated equalization error values c and d to converge the equalizer 400. However, the parts 411 and 413 do not perform equalization for the section where the 8-level precode signal is carried. That is, an e point of the switching unit 460 provides an output ‘0’ as an equalization error value e and the equalization error value e is provided for processing the 8-level precode signal. Accordingly, the FF part 411 and the FB part 413 do not update the respective filter tap coefficients.

As described above, the FF part 411 and the FB part 413 M times repeatedly perform the equalization operations with respect to the field synch signal FS stored in the field synch storage unit 440 (M<N, M is a natural number), and it is determined whether the equalizer 400 converges (S142).

If it is determined that the equalizer 400 converges up to a certain desired level, an adaptive threshold value algorithm or a fixed threshold value algorithm is applied to the filter tap coefficients of the FF part 411 and the FB part 413 to set to zero (‘0’) the filter tap coefficients corresponding to multiple paths which are less than the threshold value. FIG. 8A shows the filter tap coefficients of the FF part 411 and the FB part 413 after the operations of the first recycle mode S141 are completed, and FIG. 8B shows the settings of the filter tap coefficients used by the adaptive threshold value algorithm with respect to FIG. 8A.

That is, after operating in the first recycle mode S141, if the equalizer converges up to a predetermined level (S142), the adaptive threshold value algorithm is used to re-set the filter tap coefficients (S143). Thereafter, the second recycle mode operates to more precisely converge the equalizer 400 (S144).

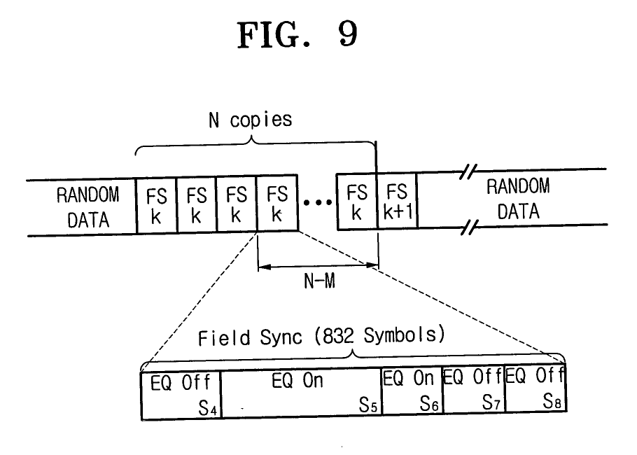

The second recycle mode repeats the field synch signal FS (N−M) times (M<N; both M and N are natural numbers) to calculate the equalization error values c and d or provide the equalization error value e. In the second recycle mode, the field synch signal FS shown in FIG. 3 is divided into sections S₄, S₅, S₆, S₇ and S₈ as shown in FIG. 9 to perform the equalization operations.

The section S₄ is one in which the latest post-ghost of a previous field synch signal (Mth) exists, the 8-level precode signal of the field synch signal (Mth) is carried, and the equalization is not performed. The section S₅ is one in which the two-level segment synch signal of the (M+1)th field synch signal FS, PN sequences, and transfer mode information are carried and the equalization error value c is calculated in the training mode. The section S₆ is one in which the reserved information of two-level signal is carried, the equalization error value d is calculated in the blind mode, and the filter tap coefficients of the FF part 411 and the FB part 413 are respectively updated. The section S₇ is one in which the fastest pre-ghost with respect to the 8-level precode signal exists and the equalization is not performed, i.e., the equalization error value e is provided, and the section S₈ is one in which the 8-level precode exists and the equalization is not performed. That is, the equalization operations are performed in the training and blind modes in the section in which the two-level segment synch signal, PN sequences, and transfer mode information are carried, so that the respective equalization error values c and d are calculated. However, the equalization operations are not performed in the section in which the 8-level precode signal exists. That is, the switching unit 460 switches to select the equalization error value e in order for the equalization error values to become ‘0’. Accordingly, the respective filter tap coefficients of the FF part 411 and the FB part 413 are not updated.

As stated above, according to the second recycle mode, the equalization operations are performed by using only the two-level field synch signal FS of a part that is not affected by the 8-level precode signal, so that the equalizer 400 can converge more safely and precisely.

Thereafter, the extent of convergence of the equalizer 400 (S145) is determined, and, if the equalizer 400 converges to a predetermined level, the equalization operations are completed.

The kth field synch signal FS stored in the field information storage unit 440 is N times repeatedly equalized, and then the first equalization process S110 starts again with respect to the (K+1)th field synch signal FS.

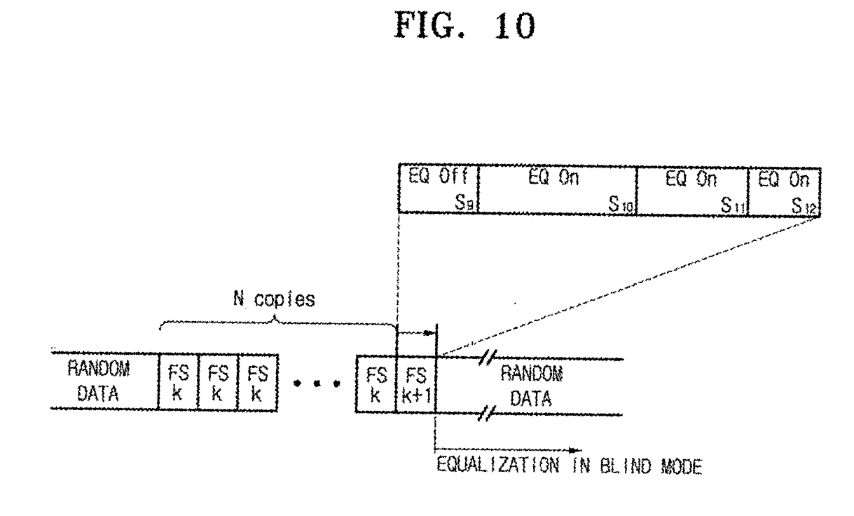

That is, as shown in FIG. 10, the equalization operations for the (K+1)th field synch signal FS are divided into sections S₉,S₁₀, S₁₁ and S₁₂. The section S₉ is one in which the equalization operations are not performed until the (k+1)th field synch signal FS is filled up in the IIR filter of the FB part 413 in order to prevent the converged level from divergence with correct data contained in the filters of the FB part 413. The section S₁₀ is one in which the two-level segment synch signal, PN sequences, and transfer mode information are carried and the equalization error value a is calculated in the training mode. The section S₁₁ is one in which the two-level reserved information is carried and the equalization error value a is calculated in the training mode. The section S₁₂ is one in which the 8-level precode signal is carried and the equalization error value b is calculated in the blind mode. The filter tap coefficients are updated based on the equalization error values a, b calculated as above.

The second equalization process S140 N times repeats the kth field synch signal stored in the field synch storage unit 440 to perform the equalization operations in the first and second recycle modes, so that the convergence speed of the equalizer 400 is enhancedand convergence is steadier.

The present invention stores a kth field synch signal in the field synch storage unit, N times repeats the stored kth field synch signal to be compared with a reference signal generated from the field synch generator, and operates the equalizer in the training mode, to thereby enhance the convergence speed of the equalizer.

Further, the present invention uses only a two-level signal except for the two-level signal affected by the 8-level precode signal of the Kth field synch signal in order to perform the equalization operations, so that the convergence is achieved more precisely and steadily.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An equalizer for a single-carrier receiver, comprising:
a filter unit comprising filters which filter received multi-path signals;
a field synch extractor which extracts a field synch signal having two signals of different levels from the received signals;
a field synch storage unit which stores a kth field synch signal of the extracted field synch signal, wherein k is a natural number; and
an error calculator which N times repeatedly uses the kth field synch signal and calculates equalization error values, wherein the filter unit uses the equalization error values to update coefficients of the filters.

2. The equalizer as claimed in claim 1, wherein:
the error calculator comprises a first recycle mode which M times repeatedly uses the kth field synch signal to calculate the equalization error values, wherein M is a natural number less than N, and
the first recycle mode calculates the equalization error values in training and blind modes with respect to one of the two signals of the kth field synch signal.

3. The equalizer as claimed in claim 2, wherein:
the error calculator comprises a second recycle mode which (N−M) times repeatedly uses the kth field synch signal to calculate the equalization error values, and
the second recycle mode calculates the equalization error values in the training and blind modes with respect to one of the two signals except for a part including pre-ghost and post-ghost of the other of the two signals.

4. The equalizer as claimed in claim 3, wherein the equalization error values become ‘0’ with respect to the one of the two signals.

5. The equalizer as claimed in claim 3, wherein the one of the two signals is a two-level signal, and the other of the two signals is an eight-level signal.

6. The equalizer as claimed in claim 2, wherein:
the equalizer further comprises a field synch generator which generates a reference signal; and
in a training mode, the error calculator further comprises a fourth adder which adds the kth field synch signal and the reference signal to calculate the equalization error values.

7. The equalizer as claimed in claim 2, wherein in a blind mode, the error calculator comprises
a decision unit which outputs the stored kth field synch signal as a predetermined level; and
a fifth adder which adds the kth field synch signal and the output signal of the predetermined level to calculate the equalization error value.

8. A method of equalizing a single-carrier receiver, comprising:
filtering received multi-path signals;
extracting a field synch signal having two signals of different levels from the received signals;
storing a kth field synch signal of the extracted field synch signal, wherein k is a natural number;
calculating equalization error values by N times repeatedly using the kth field synch signal;
updating coefficients of filters which filter the received multi-path signals using the equalization error values; and
filtering the multi-path signals using the filters having the updated coefficients.

9. The method as claimed in claim 8, wherein the calculating of the equalization error values further comprises:
M times repeatedly using the kth field synch signal to calculate the equalization error values, wherein M is a natural number less than N, and
calculating of the equalization error values in training and blind modes with respect to one of the two signals.

10. The method as claimed in claim 9, wherein the calculating of the equalization error values further comprises:
(N−M) times repeatedly using the kth field synch signal to calculate the equalization error values, and
calculating the equalization error values in the training and blind modes with respect to one of the two signals except for a part including a pre-ghost and a post-ghost of the other of the two signals.

11. The equalization method as claimed in claim 10, wherein the equalization error values become ‘0’ with respect to the one of the two signals.

12. The equalization method as claimed in claim 10, wherein the one of the two signals is a two-level signal, and the other of the two signals is a eight-level signal.

13. The equalization method as claimed in claim 9, wherein the calculating of the equalization error values in the training mode comprises:
generating a reference signal; and
adding the kth field synch signal and the reference signal to calculate the equalization error values.

14. The equalization method as claimed in claim 9, wherein the calculating of the equalization error values in the blind mode comprises:
outputting the input kth field synch signal as a predetermined level; and
adding the input kth field synch signal and the output signal of the predetermined level to calculate the equalization error value.
